(19) United States
(12) Patent Application Publication
(10) Pub. No.: US 2014/0166838 A1
(43) Pub. Date: Jun. 19, 2014

(54) Bucket Lock

(71) Applicants: Brandon Jason Murray, Riverside, CA (US); Raymond H. Losi, Jr., Westlake Village, CA (US)

(72) Inventors: Brandon Jason Murray, Riverside, CA (US); Raymond H. Losi, Jr., Westlake Village, CA (US)

(21) Appl. No.: 13/935,411

(22) Filed: Jul. 3, 2013

Related U.S. Application Data
(60) Provisional application No. 61/738,341, filed on Dec. 17, 2012.

(51) Int. Cl. F16M 11/00

(52) U.S. Cl. CPC F16M 11/00
USPC 248/346.03

(57) ABSTRACT

The present invention includes a bucket anchoring device that limits or prevents a bucket from rotating when mixing thick, heavy, or low-viscosity materials within it. The anchoring device includes a ring having a plurality of removable, flexible engagement members extending from an inner circumference of the ring. The bucket is placed in the ring such that the engagement members contact and frictionally engage an outer surface of the bucket, similar to a sprag. The user steps on footpads located on the top of the ring to provide an anchoring force to the ring and therefore the bucket, thereby preventing rotation.

### RELATED APPLICATIONS

This application claims priority to U.S. Provisional Application Ser. No. 61/738,341 filed Dec. 17, 2012 entitled Bucket Lock, which is hereby incorporated herein by reference in its entirety.

### BACKGROUND

In the construction, home improvement and other related trades, there is often the need to mix materials in a container prior to usage of those materials. Often this mixing is done with a power stirring mechanism deployed in the mixture being held in a bucket. A user often finds it difficult to keep the bucket from rotating while the stirring mechanism is activated.

Such bucket movement can cause the mixture to spill or be splattered outside of the bucket. This is wasteful and, in certain circumstances, can be very dangerous to the user and anyone else in the vicinity of the bucket.

### SUMMARY OF THE INVENTION

In one embodiment, the present invention is directed to a bucket anchoring device that limits or prevents a bucket from rotating when mixing thick, heavy, or low-viscosity materials within it. The anchoring device includes a ring having a plurality of removable, flexible engagement members extending from an inner circumference of the ring. The bucket is placed in the ring such that the engagement members contact and frictionally engage an outer surface of the bucket, similar to a sprag. The user steps on footpads on the device's top surface to provide an anchoring force to the ring and therefore the bucket, thereby preventing rotation.

In one embodiment, the ring includes a plurality grooves to which the engagement members can attach to. Preferably, the ring in includes at least two sets of grooves which are located at different depths or diameters in the ring. In this respect, the engagement members can accommodate different diameter buckets depending on which grooves they are coupled to.

### BRIEF DESCRIPTION OF THE DRAWINGS

These and other aspects, features and advantages of which embodiments of the invention are capable of will be apparent and elucidated from the following description of embodiments of the present invention, reference being made to the accompanying drawings, in which

FIG. 1 is a perspective view of a bucket locking device with a bucket according to the present invention;

FIG. 2 is a perspective view of the bucket locking device of FIG. 1;

FIG. 3 is a bottom view of the bucket locking device of FIG. 1;

FIG. 4 is a top view of the bucket locking device of FIG. 1;

FIG. 5 is a side view of the bucket locking device of FIG. 1;

FIGS. 6-9 are various views of an engagement member;

FIG. 10 is a top view of an arc segment; and,

FIG. 11 is a bottom view of the arc segment of FIG. 10.

FIG. 12 is a perspective view of an alternate bucket locking device.

FIG. 13 is a bottom view of the alternate bucket locking device of FIG. 12.

### DESCRIPTION

Specific embodiments of the invention will now be described with reference to the accompanying drawings. This invention may, however, be embodied in many different forms and should not be construed as limited to the embodiments set forth herein; rather, these embodiments are provided so that this disclosure will be thorough and complete, and will fully convey the scope of the invention to those skilled in the art. The terminology used in the detailed description of the embodiments illustrated in the accompanying drawings is not intended to be limiting of the invention. In the drawings, like numbers refer to like elements.

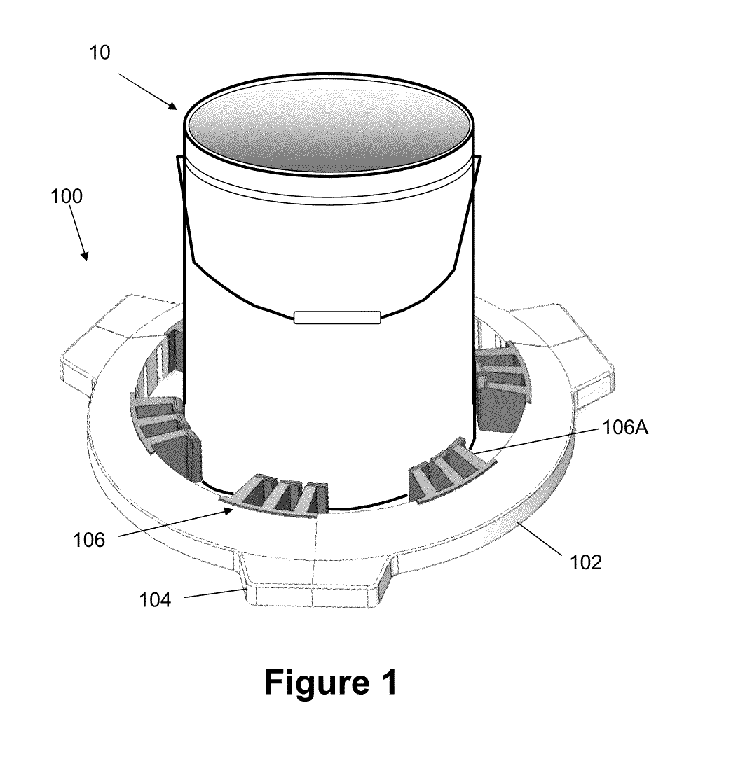

FIG. 1 illustrates an embodiment of a bucket anchor device 100 which can prevent or limit a bucket 10 from rotating, especially when using a power stirring device within the bucket 10. Generally, the user stands on the anchor device 100 to prevent movement of the device 100 relative to the ground while the device 100 frictionally engages an outer surface of the bucket 10 to prevent rotation of the bucket 10 relative to the device 100. In this respect, the weight of the user helps prevent the bucket 10 from rotational and possibly vertical movement, especially when stirring buckets containing thick viscosity material, such as plaster, stucco, concrete, mortar, thinset, grout, compost, or similar materials.

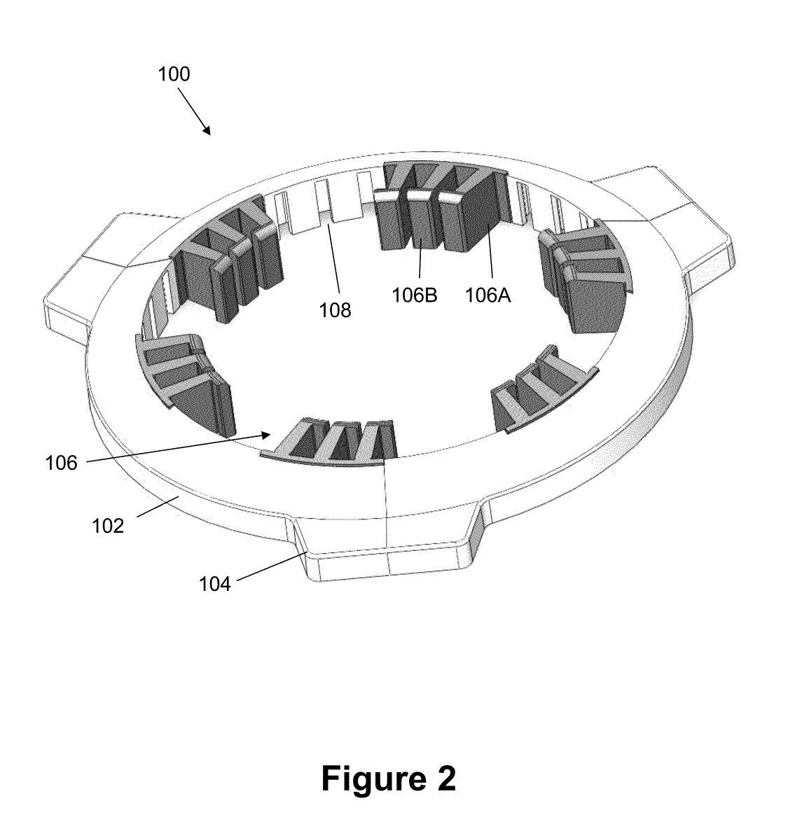

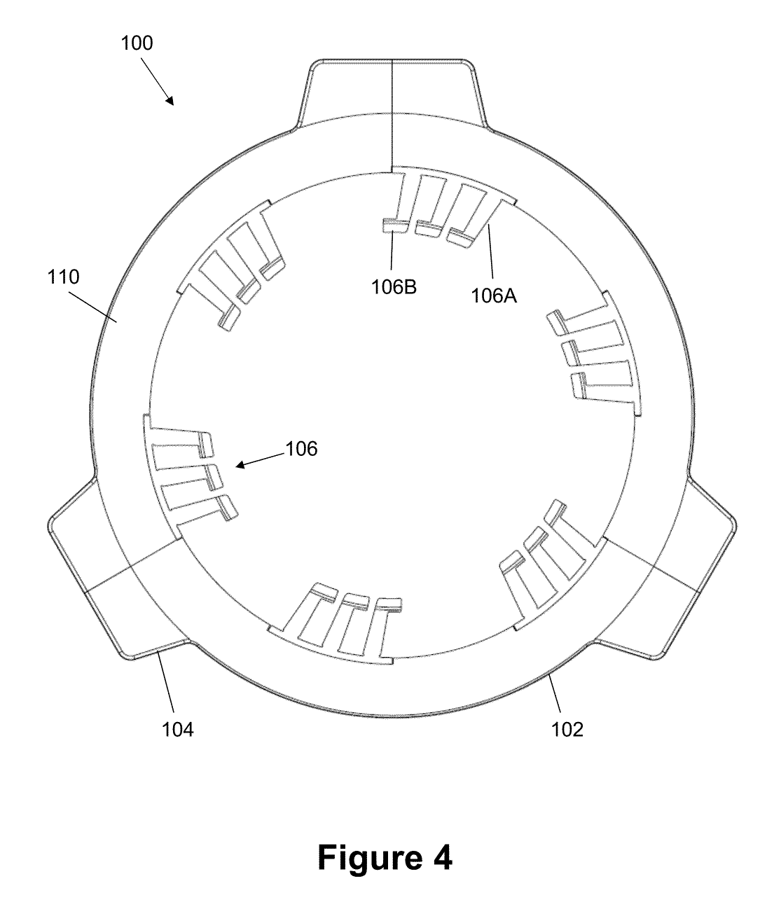

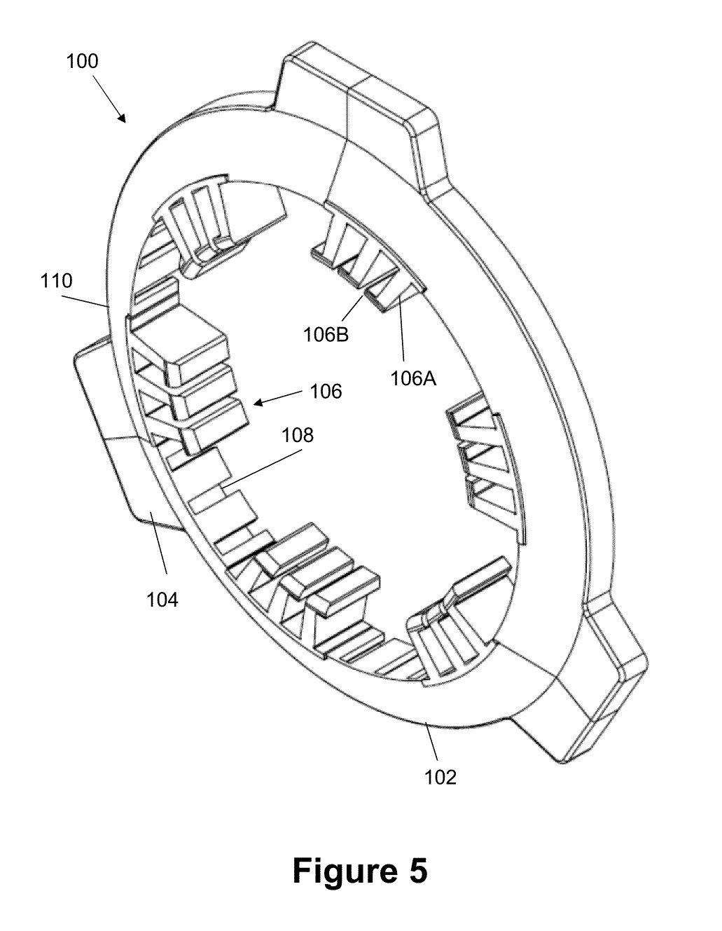

In one embodiment shown best in FIGS. 1-5, the anchor device 100 includes a ring 102 that fits around the bucket 10 and a plurality of flexible engagement members 106 extend from an inner portion of the ring 102 (i.e., the ring's aperture) to frictionally engage the bucket 10. In the present embodiment, six engagement members 106 are depicted, however, any number of engagement members 106 are contemplated, such as between 2 and 10 engagement members or even a single circular engagement member.

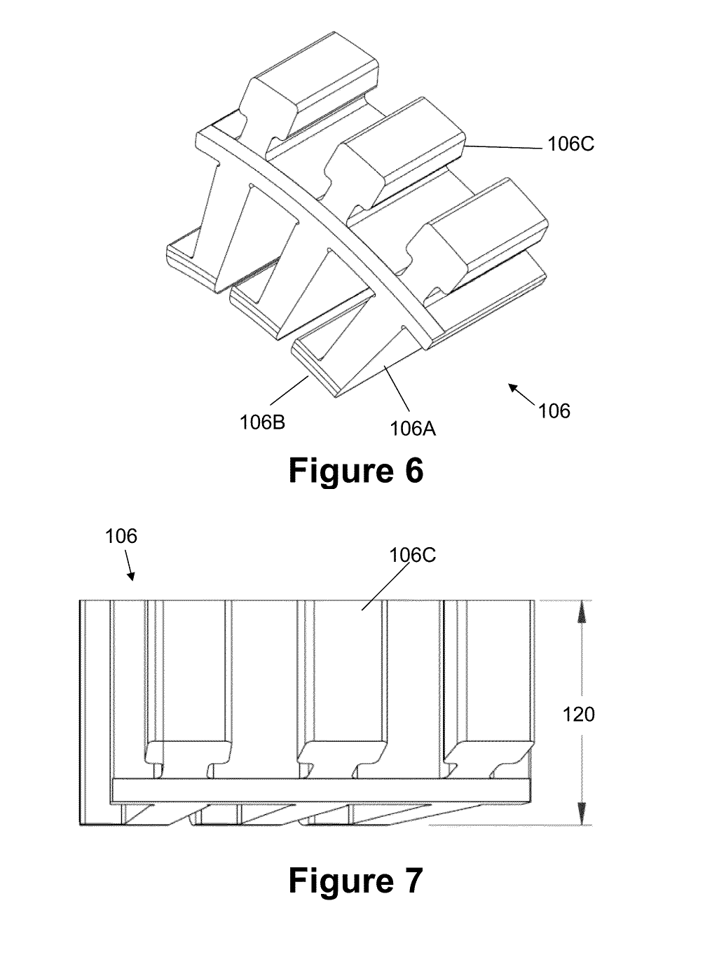

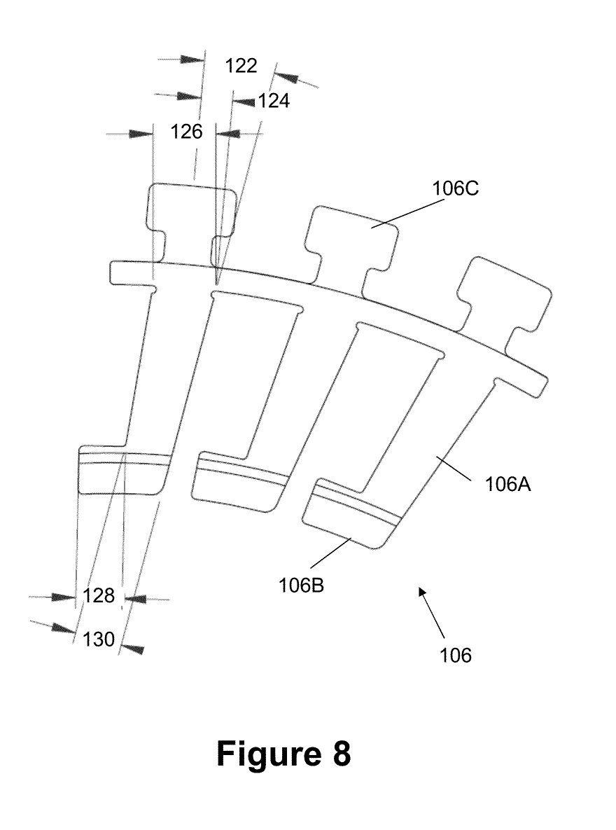

In the present embodiment, each engagement member 106 includes a plurality of fingers 106A that extend from a curved base portion and terminate with a flat “L” surface 106B, as best seen in FIGS. 6-9. Preferably, the fingers 106A are angled or lean in a counter-clockwise direction. In one specific example shown in FIG. 8, the fingers 106A have an angle 122 of about 5 or about 10 degrees in a counter-clockwise direction relative to a line that perpendicularly crosses the ring 102 or base of the engagement member 106. In the same example, the fingers have a final distal width 130 of about 0.375 inches that increases to a final proximal width 126 of about 0.500 inches (e.g., a final proximal half-width 124 of about 0.250 inches). Preferably, the fingers 106A have a length such that, when the engagement members 106 are connected to the ring 102, the anchor device 100 can accept and engage a bucket of predetermined size. For example, the fingers 106A may have a length such that the device 100 accommodates and frictionally engages a bucket 10 having a diameter of about 7.25 inches, 7.50 inches, 7.75 inches, about 8 inches, about 11.25 inches, 11.50 inches, 11.75 inches, or about 12 inches.

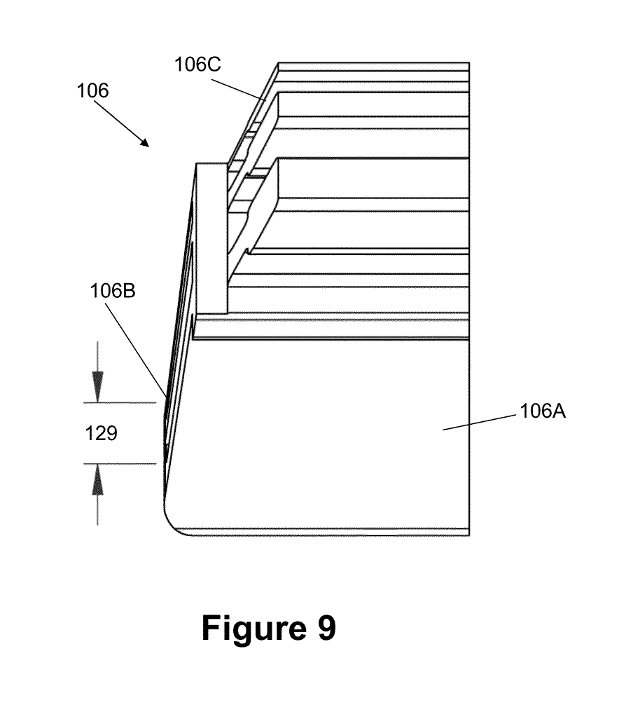

With further reference to the example of FIGS. 8 and 9, the L region 106B has an overhanging length 128 of about 0.370 inches, a thickness 129 of about 0.375 inches and is generally perpendicular to the base portion of the engagement member 106. While the L region 106B can be composed of the same material as the fingers 106A, this region 106B may also be composed of a different material that may better frictionally engage a bucket, such as low durometer rubber or silicone.

Preferably, the engagement members 106 include a mechanism for removable mounting at various locations around the inner surface of the ring 102. In one example, the base portion of the engagement members 106 include a plurality of anchoring ribs 106C, seen best in FIGS. 6-8, that are shaped to slide into channels 108. In the present example, the engagement members 106 have three anchoring ribs 106C, each having similar spacing and angular position to slide into and thereby mate with three channels 108.

Many types of commercially available products are sold in bucket sizes of common volumes, such as 1, 3, 3.5, 5, and 7 gallon buckets. However, depending on the manufacturer and bucket design, some buckets of a common size may have diameters that vary from each other. For example, many commercially available 2, 2.5, 5, and 7 gallon buckets will have lower-region diameters that vary by about 0.5 inches from other, similarly sized bucket designs. Similarly, different volume buckets may have lower-region diameters that vary from each other.

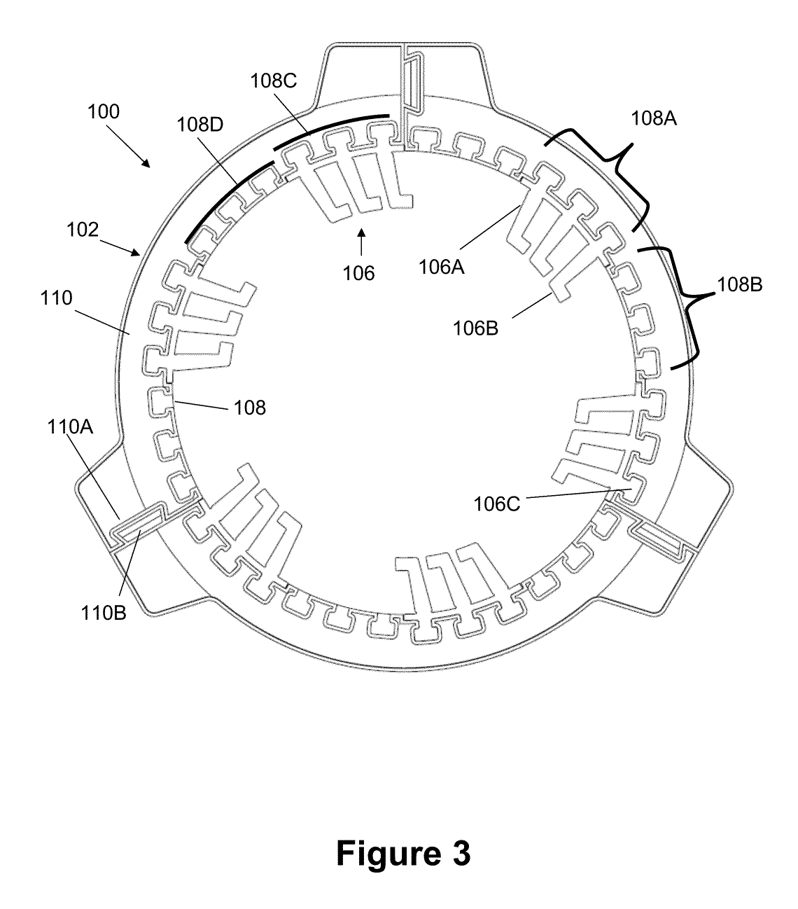

The anchor device 100 can accommodate different diameter sizes of buckets by including groups of channels 108 that are set back within the ring 102 by various amounts. For example, the embodiment of FIG. 3 shows a bottom view of the device 100 and includes a first plurality of channels 108A and a second plurality of channels 108B. The first plurality of channels 108A are set radially outward to a further diameter 108C within the ring 102 relative to the position 108D of the second plurality of channels 108B. In one example, the difference in position between the first and second plurality of channels 108A and 108B is about 0.5 inches. Hence, the user can move the engagement members 106 to engage with either the first plurality of channels 108A to accommodate larger diameter buckets 10 and the second plurality of channels 108B to accommodate smaller diameter buckets 10.

While the present example shows a device 100 with channels 108 having one of two positions, it should be understood that additional groups with additional spacing are possible, such as a third plurality of channels that are located radially beyond the first plurality of channels. It should also be understood that different sized engagement members 106 having shorter or longer fingers 106A can also be used to accommodate different sized buckets 10.

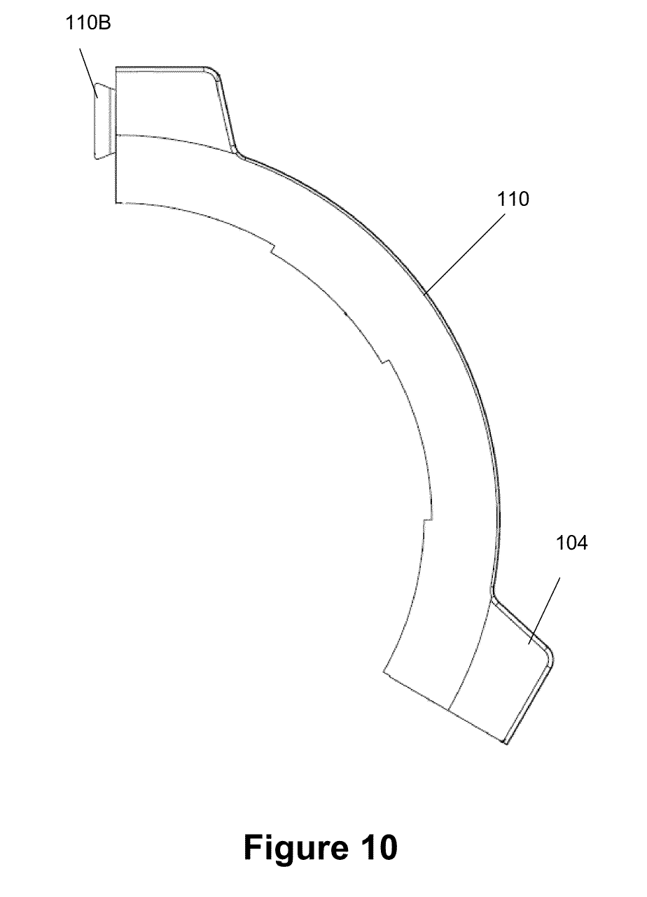

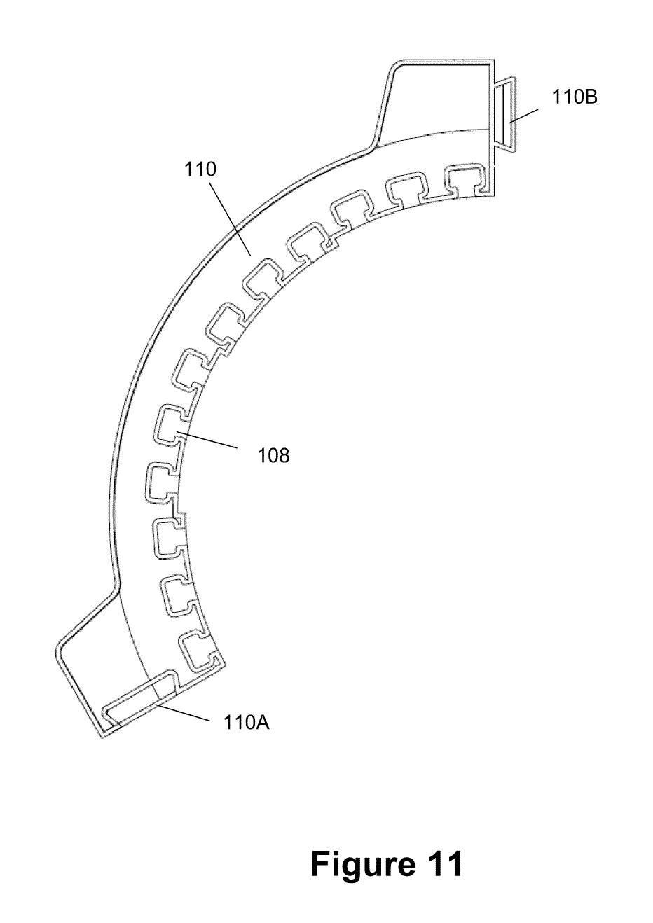

In one embodiment, the ring 102 of the device 100 can be composed of multiple components that can be disassembled for smaller storage size. For example, FIGS. 3, 10 and 11 illustrates that the ring 102 can be composed of three arc segments 110, each having a tongue member 110B on one end and a groove member 110A on the opposite end. These tongue members 110B and groove members 110A can be connected to adjacent arc segments to removably engage each other and form the ring 102.

In one example use, the user assembles the bucket anchor device 100 by first connecting each arc segment 110 via the tongue members 110B and groove members 110A. Next, the user connects the engagement members 106 (e.g., 6 engagement members) to either the first plurality of channels 108A or the second plurality of channels 108B, depending on the size of the bucket 10 to be anchored.

Next, the bucket 10 is pushed into the center of the ring 102 so that the engagement members 106 engage a bottom portion of the bucket 10. Alternately, the ring 102 can be assembly around bucket 10. Finally, the user stands on foot platforms 104 to maintain both the anchor device 100 and the bucket 10 in place and begins mixing the bucket's contents with limited or no rotations movement of the bucket 10.

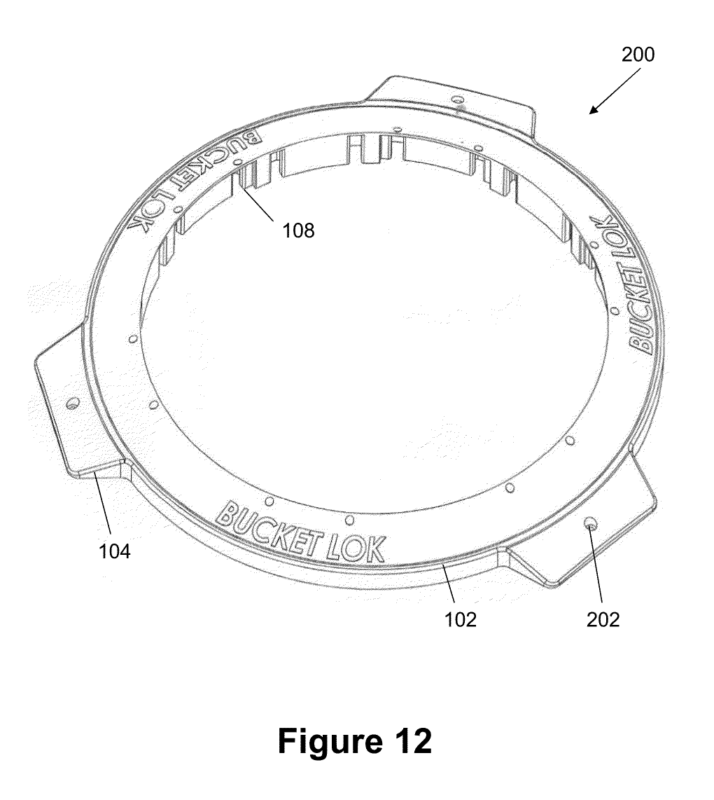

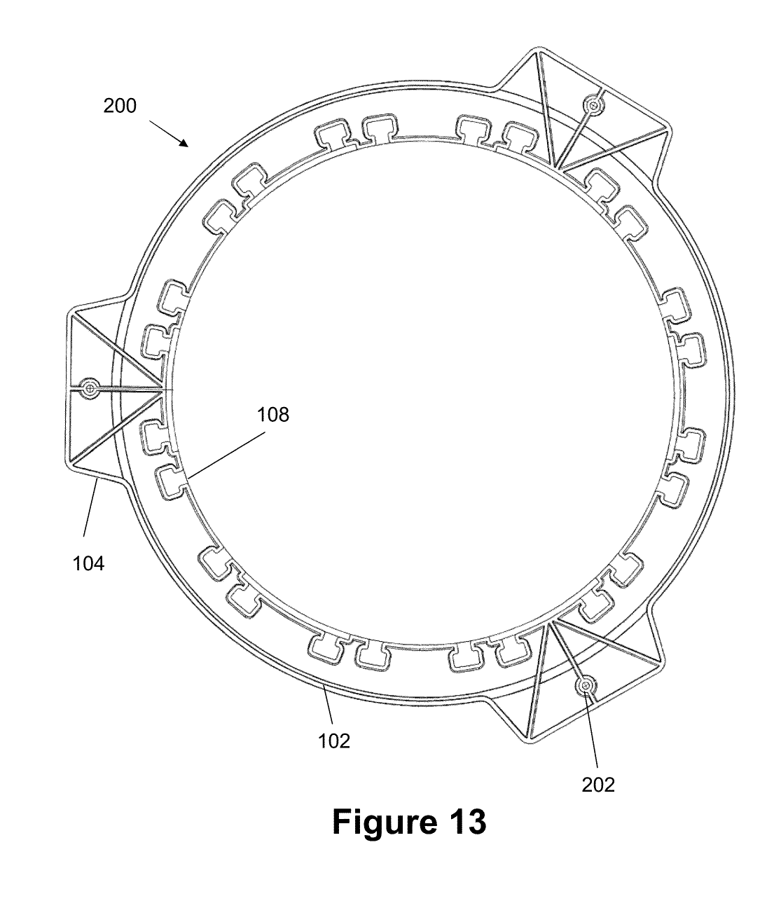

FIGS. 12 and 13 illustrate an alternate embodiment of the anchor device 200 which is generally similar to the previously described embodiment 100. However, the anchor device 200 includes a ring 102 formed from a single, unitary piece of material instead of the previously described arc segments 110.

Additionally, the device 200 includes one or more inset apertures 202 that pass through the foot platforms 104. These apertures are preferably sized for common-sized screws or nails, allowing a user to screw or nail the anchor device 200 into an anchoring material, such as wood (e.g., 2×4s or a sheet of plywood), below it. If this material is large enough and/or heavy enough, a user may not need to stand on the foot platforms 104 during mixing.

Finally, as best seen in FIG. 13, each group of channels 108 includes two channels 108 instead of the three channels shown on the previously described anchoring device 100. Hence, the engagement members 106 preferably include two mating anchoring ribs 106C, as well.

While a ring shape has been disclosed in the present embodiments, it is also contemplated that other shapes of the device 100 are possible. For example, the device may have an arc shape, a “U” shape, a square shape, an oval shape, a triangle shape, or may even be two separate arc shapes.

Although the invention has been described in terms of particular embodiments and applications, one of ordinary skill in the art, in light of this teaching, can generate additional embodiments and modifications without departing from the spirit of or exceeding the scope of the claimed invention. Accordingly, it is to be understood that the drawings and descriptions herein are proffered by way of example to facilitate comprehension of the invention and should not be construed to limit the scope thereof.

What is claimed is:

1. A bucket anchor comprising:
a ring member;
a plurality of engagement members removably connectable to said ring and extending towards a center of said ring;
said ring member and said plurality of engagement members forming a center aperture sized to frictionally engage an outer diameter of a bucket.

2. The bucket anchor of claim 1, wherein said ring member further comprises a first plurality of engagement member connection points located at a first ring diameter and a second plurality of engagement member connection points located at a second ring diameter.

3. The bucket anchor of claim 1, wherein each of said plurality of engagement members comprises a base portion and a plurality of flexible finger members.

4. The bucket anchor of claim 1, wherein each of said plurality of engagement members comprises a plurality of flexible finger members angled in a counter-clockwise orientation around said ring.

5. The bucket anchor of claim 1, wherein said ring is further comprised of a plurality of arc members that are selectively connectable to each other to form said ring.

6. The bucket anchor of claim 1, wherein said ring further comprises a plurality of grooves located around an inner surface of said ring and wherein said engagement members include a plurality of tongue members shaped to engage some of said plurality of grooves.

7. The bucket anchor of claim 1, wherein said plurality of engagement members each comprise a plurality of finger members that extend from a base; wherein said plurality of finger members are L-shaped.

8. A bucket-bracing device, comprising:
a body having an aperture;
a plurality of engagement members removably connectable around an inner surface of said aperture;
said plurality of engagement members positionable at a first diameter around said aperture and at a second diameter around said aperture.

9. The bucket-bracing device of claim 8, wherein said bucket-bracing device is configured to engage a first bucket diameter size when said engagement members are positioned at said first diameter around said aperture and wherein said bucket-bracing device is configure to engage a second bucket diameter size when said engagement members are positioned at said second diameter around said aperture.

10. The bucket-bracing device of claim 8, wherein each of said plurality of engagement members further comprise a base portion; a plurality of finger members connected to a first side of said base portion; and a plurality of ridge members connected to a second side of said base portion.

11. The bucket-bracing device of claim 10, wherein each of said finger members are L-shaped and further configured to lean in a counter-clockwise direction when connected around said aperture.

12. The bucket-bracing device of claim 8, wherein said body further comprises a plurality of foot platforms structured to support human weight.

13. The bucket-bracing device of claim 8, wherein said first diameter is about 0.5 inches larger than said second diameter.

14. The bucket-bracing device of claim 8, wherein said engagement members are composed of a flexible material.

15. The bucket-bracing device of claim 8, wherein said body further comprises a plurality of arc members that are connectable to each other to form a ring shape.

16. A method of locking a bucket from rotation, comprising:
placing a bucket within an aperture of a bucket-bracing device;
frictionally engaging said bucket with a plurality of engagement members; and,
standing on a top surface of said bucket-bracing device.

17. The method of claim 16, wherein said placing said bucket within said aperture is preceded by adjusting a diameter of said engagement members within said aperture.

18. The method of claim 17, wherein said adjusting said diameter of said engagement members further comprises moving said engagement members from a first plurality of attachment locations to a second plurality of attachment locations.

19. The method of claim 18, wherein said plurality of engagement members are angled in a counter-clockwise direction.

20. The method of claim 18, wherein said first plurality of attachment locations and second plurality of attachment locations are channels aligned along an inner surface of said aperture.
